(19) United States
(12) Patent Application Publication
(10) Pub. No.: US 2022/0308553 A1
(43) Pub. Date: Sep. 29, 2022

(54) A Method of Making Dental Articles

(71) Applicant: AGENCY FOR SCIENCE, TECHNOLOGY AND RESEARCH, Singapore (SG)

(72) Inventors: Fuke Wang, Singapore (SG); Chaobin He, Singapore (SG); Yi Ting Chong, Singapore (SG); Evan Laurence Williams, Singapore (SG)

(21) Appl. No.: 17/610,743

(22) PCT Filed: May 14, 2020
(86) PCT No.: PCT/SG2020/050280

§ 371 Date: Nov. 12, 2021

(30) Foreign Application Priority Data
May 15, 2019 (SG) 10201904389W

(51) Int. Cl. G05B 19/4099; A61C 19/10; A61C 13/00; A61C 13/087; B33Y 50/00; B29C 64/386; B33Y 70/00

(52) U.S. Cl. CPC G05B 19/4099; A61C 19/10; A61C 13/0004; A61C 13/0019; A61C 13/087; B33Y 50/00; B29C 64/386; B33Y 70/00; G05B 2219/49023; B29K 2995/002; B29L 2031/753

(57) ABSTRACT

A method of making an article having a desired color, the method comprising the steps of: (a) providing a color array, said array comprising a plurality of distinct color points, each color point being independently composed of a resin mixture comprising one or more masterbatch resins; (b) comparing the desired color with the color points on the color array and selecting a color point that substantially corresponds to the desired color of the article; (c) identifying the resin mixture corresponding to said selected color point; and (d) making the article using said identified resin mixture.

### TECHNICAL FIELD

The present invention generally relates to a method of making dental articles.

### BACKGROUND ART

It is observed that the current generation of people are more conscious with appearance and beauty. One of the aspects of such is to have a beautiful set of teeth. Accordingly, the demand for dental aesthetics has also grown comparatively in the last few years which led to an increasing demand for 3D printing in dental industry. The demand has also increased due to advancement in technologies which enable dentists to perform the dental procedure with great accuracy, high efficiency and minimal trauma to the patients. Dental 3D printing is performed by additive process which is programmed by computer aided design (CAD) files. The global dental 3D printing market is expected to be worth US$3,427.1 million dollars by the end of 2025.

The dental 3D printing can be applied generally on three main kinds of material, including metals, polymer resins and ceramic. Polymer resin accounts for the largest market share in dental 3D printing with a share of 58.0% in 2016 due to advancement in new technology for developing cost effective polymeric materials.

The 3D printing has been applied successfully in dental implants, braces, dentures, crowns and bridges, etc. In addition to the mechanical requirements, special attention to the colour of the teeth to be printed is required. In traditional dental industry, approximately 50% of remakes for aesthetic restorations are the result of failing to match the shades of the patients' teeth accurately.

Indeed, in traditional dental restorations and aesthetic dentistry, accurate shade matching is one of the most challenging aspects. The close matching of an artificial restoration with natural dentition is a complex process because of the large variation in natural tooth colours and the complexity involved in colour matching. The colour/shade matching cannot be regarded as a simple or an easy task because it is affected by several factors such as the chosen material, the surface texture, the light sources and the patterns of reflection and absorption of light on the teeth.

Color can be described with three parameters: hue, chroma and value, all of which affect the final shade perceived by the eye. In 1936, Munsell described the three dimensions of color to opaque objects and now this language has become acceptable worldwide. Hue is the base colour, chroma is the saturation, or intensity of the hue, and value is the greyness of the colour ranging from black to pure white.

Two preconditions are required to obtain a natural looking restoration: (1) availability of the materials with different colours, saturation, and values, together with (2) a reliable colour matching method. When preparing a dental aesthetic restoration, resin composite is the best choice of material because it may be prepared having a color that is closest to the natural colour of teeth. Various elements such as surface roughness, sample thickness and background colour can be adjusted in the composite materials. A variety of dental restorative materials were introduced in the 1950s. This allowed an improvement in the aesthetic performance of restorations. The colour matching using dental composites is achieved by adding different pigments.

The resin composite also shows other advantages as compared to other dental materials, for example, a much lower cost compared to equivalent ceramic materials and good mechanical properties. Also, composite materials allow for a much easier manufacturing process than other materials.

Currently, in traditional dental treatment, visual shade matching is the commonly used method for choosing the restoration colour, in which a colour standard from a commercially available dental shade guide is matched with the patient's tooth. Using this method, shade matching is accomplished by visually comparing a tooth with multiple standards, usually represented as shade guide tabs. However, this technique is very subjective and the matching is affected by numerous ambient factors and the colour vision acuity of the clinician, and colour perception varies from one person to another.

In light of the above, it can be understood that the dental 3D printing is a balance of the science in dentistry and aesthetic printing. Color matching during dental 3D printing is carried out to ensure accuracy, consistency and predictable results. Unfortunately, until now, there are limited efforts for providing a solution for shade matching in dental 3D printing.

In view of the above reasons, there is a need to provide a method for preparing a dental article that overcomes, or at least ameliorates, one or more of the disadvantages described above.

### SUMMARY OF INVENTION

According to one aspect, there is provided a method of making an article having a desired color, the method comprising the steps of:

(a) providing a color array, said array comprising a plurality of distinct color points, each color point being independently composed of a resin mixture comprising one or more masterbatch resins;

(b) comparing the desired color with the color array and selecting a color point that substantially corresponds to the desired color of the article;

(c) identifying the resin mixture corresponding to said selected color point; and

(d) making the article using said identified resin mixture.

Advantageously, the method may be used to prepare an article (e.g., a dental prosthetic) having a color which is substantially identical to that of a reference object (e.g., a human tooth).

The masterbatch resins may be blended in particular ratios to achieve at least 36 or at least 144 color points. Advantageously, the method of the present disclosure may be used to prepare an article of a desired color on demand using the mastebatch resins without having to store a large number of color resins (e.g., 36, and 144) or even higher number of color resins, for the preparation.

Furthermore, the method may advantageously result in more precise color matching by providing a large number of color points (e.g., 36, and 144) across a color gradient. For example, the method of the present disclosure may advantageously result in a color difference value (ΔE) between the color of the resultant article and the desired color of less than 6. The method of the present disclosure may further advantageously result in a ΔE of less than 4. Even more advantageously, the disclosed method may result in a ΔE of less than 2. Even more advantageously, the disclosed method may result in a ΔE of about 0.

### Definitions

The following words and terms used herein shall have the meanings indicated:

The term “masterbatch resin” as used herein refers to a premixed resin composition which may be combined with one or more other distinct “masterbatch resin” to provide a resin mixture which may be used in 3D printing process. The term “masterbatch resin” may refer to a solid or a liquid resin composition. The term “masterbatch resin” may be a homogeneous mixture.

The term “resin mixture” as used herein refers to a mixture formed by the one or more masterbatch resin of the present disclosure. The term “resin mixture” may refer to a solid or a liquid mixture. The term “resin mixture” may be a homogeneous mixture.

The term “color point” as used herein refers to a resin composition formed on the color array of the present disclosure. The resin composition may be prepared using the masterbatch resin as disclosed herein.

The term “color array” as used herein refers to an arrangement of a plurality of distinct color points. The arrangement of the color points on the color array may be in accordance with a color gradient with variations in the hue, chroma and/or value. Alternatively, the arrangement of the color points on the color array may be random.

The term “hue” refers to an identified and distinguished color. The term “hue” may be the name of the color, e.g. blue, yellow, green, which corresponds to the reflected wavelength. The term “chroma” refers to the purity of the color, quantified based on the saturation of the color. For instance, the lighter the color, the lower the saturation. The term “value” refers to the lightness or darkness of a color. For instance, the clearer the color, the greater is the value (brightness); the darker the color, the lower is the value. A full white represents the maximum value on the intensity scale (100), while black shows the minimum value of zero (0).

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a method of making an article will now be disclosed.

The present disclosure relates to a method of making an article having a desired color, the method comprising the steps of:

(a) providing a color array, said array comprising a plurality of distinct color points, each color point being independently composed of a resin mixture comprising one or more masterbatch resins;

(b) comparing the desired color with the color points on the color array and selecting a color point that substantially corresponds to the desired color of the article;

(c) identifying the resin mixture corresponding to said selected color point; and

(d) making the article using said identified resin mixture.

The article may comprise a polymeric material. The article may be a dental article.

The desired color of the article may be substantially identical to the color of a reference object. The desired color may be determined based on the color of the reference object.

The reference object may be any objects which are substantially three-dimensional. The reference object may be a human tooth.

The color array may comprise 4, 8, 12, 16, 20, 24, 28, 32, 36, 40, 44, 48, 52, 56, 60, 64, 68, 72, 76, 80, 84, 88, 92, 96, 100, 104, 108, 112, 116, 120, 124, 128, 132, 136, 140, 144, 148, 152, 156, 160, 164, 168, 172, 176, 180, 184, 188, 192, 196, 200, 204, 208, 212, 216, 220, 224, 228, 232, 236, 240, 244, 248, 252, 256, 260, 264, 268, 272, 276, 280, 284, 288, 292, 296, 300, 304, 308, 312, 316, 320, 324, 328, 332, 336, 340, 344, 348, 352, 356, 360, 364, 368, 372, 376, 380, 384, 388, 392, 396 or 400 distinct color points. In embodiments, the color array may comprise 36 or 144 color points. In other embodiments, the color array may comprise at least 36 or at least 144 color points.

Each color point may be independently composed of a resin mixture comprising one or more masterbatch resins. In embodiments, the color point may be independently composed of a resin mixture comprising two, three, four, five, six, or seven masterbatch resins. In other embodiments, the resin mixture may comprise at least two, three, four or five masterbatch resins. The resin mixture may preferably comprise at least two resins. The resin mixture may also preferably comprise three, four or five masterbatch resins.

The resin mixture may homogenous.

Each color point may have a distinct color value. The color value may be in RGB (Red Green Blue) coordinates or in the CIE (International Commission of l'Eclairage) system. In a preferred embodiment, each color point on the color array may have a color value defined in accordance with the CIE system. The color value may be expressed in L*, a* and b* values under the CIE system.

Each masterbatch resin may comprise one or more components selected from the group consisting of a hard resin, a dilute resin, dye particles, filler particles, initiator and pigments. Each masterbatch resin may comprise a hard resin, a dilute resin, dye particles, filler particles, and an initiator. In embodiments, the masterbatch resin may comprise a hard resin, a dilute resin, dye particles, filler particles, an initiator and a stabilizer.

The hard resin of the masterbatch resin may comprise bisphenol A dimethacrylate (Bis-DMA), bisphenol A diglycidyl ether methacrylate (Bis-GMA), ethoxylated bisphenol A dimethacrylate (Bis-EMA), Tricyclo[5.2.1.02,6]decanedimethanol diacrylate, bisphenol A glycerolate diacrylate, bisphenol A ethoxylate diacrylate, bisphenol A ethoxylate dimethacrylate oligomers, bisphenol F ethoxylate diacrylate oligomers, bis(4-hydroxyphenyl)dimethylmethane diglycidyl ether, polyisocyanate acrylate, urethane acrylate oligomers, branched hexa-functional aliphatic urethane acrylate, DER332, bisphenol A diglycidyl ether, or bisphenol F diglycidyl ether. In a preferred embodiment, the hard resin may comprise bisphenol A dimethacrylate.

The masterbatch resin may comprise about 20 to about 80 wt. % of the hard resin, i.e. about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 42 wt. %, about 44 wt. %, about 46 wt. %, about 48 wt. %, about 50 wt. %, about 52 wt. %, about 54 wt. %, about 56 wt. %, about 58 wt. %, about 60 wt. %, about 62 wt. %, about 64 wt. %, about 66 wt. %, about 68 wt. %, about 70 wt. %, about 72 wt. %, about 74 wt. %, about 76 wt. %, about 78 wt. %, or about 80 wt. % of the hard resin. In a preferred embodiment, the masterbatch resin may comprise about 50 wt. % of the hard resin.

The dilute resin of the masterbatch resin may comprise poly(ethylene glycol) diacrylate, di(ethylene glycol) diacrylate, tetra(ethylene glycol) diacrylate, 1,4-butanediol diacrylate, hydroxyl ethyl methacrylate, 3,4-epoxy-cyclohexylmethyl methacrylate (METHB), triethylene glycol dimethacrylate (TEGDMA), tertiobutyl cyclohexanol methacrylate, 1,6-bis[2-(methacryloyloxy) ethoxycarbonylamino]-2,4,4-trimethylhexane (UDMA), 3,3,5-trimethyl cyclohexanol methacrylate, dipentaerythritol penta-/hexa-acrylate, poly(ethylene glycol) diglycidyl ether, 1,4-butanediol diglycidyl ether, resorcinol diglycidyl ether, diglycidyl 1,2-cyclohexanedicarboxylate, poly(propylene glycol) diglycidyl ether, tetrahydrofurfuryl methacrylate, or neopentyl glycol diglycidyl ether. In a preferred embodiment, the dilute resin may comprise poly(ethylene glycol) diacrylate.

The masterbatch resin may comprise about 20 to about 80 wt. % of the dilute resin, i.e. about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 42 wt. %, about 44 wt. %, about 46 wt. %, about 48 wt. %, about 50 wt. %, about 52 wt. %, about 54 wt. %, about 56 wt. %, about 58 wt. %, about 60 wt. %, about 62 wt. %, about 64 wt. %, about 66 wt. %, about 68 wt. %, about 70 wt. %, about 72 wt. %, about 74 wt. %, about 76 wt. %, about 78 wt. %, or about 80 wt. % of the dilute resin. In a preferred embodiment, the masterbatch resin may comprise about 30 wt. % of the dilute resin.

The dye particles of the masterbatch resin may comprise inorganic dye particles or organic dye particles.

The inorganic dye particles may be selected from the group consisting of: Barium sulfate (BaSO₄), Titanium(IV) oxide (TiO₂), Zinc oxide (ZnO), Gold nanoparticles, Cobaltous orthophosphate, Cobalt(II) stannate, Calcium copper silicate, Ferric hexacyanoferrate, Zinc green (CoZnO₂), Potassium cobaltinitrite (K₃Co(NO₂)₆), Monohydrated ferric oxide (Fe₂O₃.H₂O), Carbon Black, Iron black, and Titanium(III) oxide (Ti₂O₃).

The organic dye particles may be selected from the group consisting of: fluorescein, auramine, naphthol, amido black, alizarin, and neutral red.

The masterbatch resin may comprise about 0.1 to about 5 wt. % of the dye particles, i.e. about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, or about 5.0 wt. % of the dye particles.

The filler particles of the masterbatch resin may comprise silicon dioxide, kaolin, titanium dioxide, or iron(III) oxide. The filler particles may be the pigments of the masterbatch resin.

The masterbatch resin may comprise about 1 to about 20 wt. % of the filler particles, i.e. about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the filler particles. In a preferred embodiment, the masterbatch resin may comprise about 15 wt. % of the filler particles. In another preferred embodiment, the masterbatch resin may comprise about 5 wt. % of the filler particles.

The initiator may comprise a UV photoinitiator or a visible photoinitiator. The initiator may be bis(2,4,6-trimethyl benzoyl)phenylphosphine oxide (IRGACURE 819), phenylbis(2,4,6-trimethylbenzoyl)phosphine oxide (BAPO), 2,4,6-trimethylbenzoyl diphenyl phosphine (TPO), 2-hydroxy-2-methyl-1-phenyl-1-propane (DAROCUR 1173), or benzophenone (BP). In a preferred embodiment, the initiator may be phenylbis(2,4,6-trimethylbenzoyl)phosphine oxide (BAPO) or 2,4,6-trimethylbenzoyl diphenyl phosphine (TPO).

The masterbatch resin may comprise about 0.1 to about 5 wt. % of the initiator, i.e. about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.4 wt. %, about 1.6 wt. %, about 1.8 wt. %, about 2.0 wt. %, about 2.2 wt. %, about 2.4 wt. %, about 2.6 wt. %, about 2.8 wt. %, about 3.0 wt. %, about 3.2 wt. %, about 3.4 wt. %, about 3.6 wt. %, about 3.8 wt. %, about 4.0 wt. %, about 4.2 wt. %, about 4.4 wt. %, about 4.6 wt. %, about 4.8 wt. %, or about 5.0 wt. % of the initiator. In a preferred embodiment, the masterbatch resin may comprise about 0.8 wt. % of the initiator.

The stabilizer may be 2,5-bis(5-tert-butyl-benzoxazol-2-yl)thiophene, 4-methoxyphenol, butylatedhyrdorxytoluene, or Sudan I-IV.

The masterbatch resin may comprise about 0 to about 0.5 wt. % of the stabilizer, i.e. about 0.1 wt. %, about 0.2 wt. %, about 0.3 wt. %, about 0.4 wt. %, or about 0.5 wt. of the stabilizer. In a preferred embodiment, the masterbatch resin may comprise about 0.2 wt. % of the stabilizer.

The method of the present disclosure may comprise a step of comparing the desired color with the color array and selecting a color point that substantially corresponds to the desired color of the article.

The comparing step of the method may comprise determining the CIE color values of the reference object, L*1, a*1 and b*1. The CIE color values may be determined by measuring the spectral reflectance S(λ) or transmittance of the reference object using a UV-VIS spectrophotometer. The CIE color values may be determined by calculating the X, Y and Z color coordinate values from the measured spectral reflectance S(λ) or transmittance of the reference object in accordance with the following equations:

$$X = \frac{1}{N} {\int }_{λ = 390}^{λ = 830} {x}^{-} ( λ ) S ( λ ) I ( λ ) d λ$$

$$Y = \frac{1}{N} {\int }_{λ = 390}^{λ = 830} {y}^{-} ( λ ) S ( λ ) I ( λ ) d λ$$

$$Z = \frac{1}{N} {\int }_{λ = 390}^{λ = 830} {z}^{-} ( λ ) S ( λ ) I ( λ ) d λ$$

$$N = {\int }_{λ = 390}^{λ = 830} {y}^{-} ( λ ) I ( λ ) d λ$$

where x⁻, y⁻ and z⁻ are the CIE standard observer functions with functions as shown in FIG. 7(a);

where I(λ) is the spectral power distribution of a CIE standard illuminant D65 with function as shown in FIG. 7(b).

The calculated X, Y and Z values may be converted to L*1, a*1 and b*1 values in accordance with the following equations:

$${L}_{1}^{z *} = 116 f ( \frac{Y}{{Y}_{n}} ) - 16$$

$${a}_{1}^{*} = 500 ( f ( \frac{X}{{X}_{n}} ) - f ( \frac{Y}{{Y}_{n}} ) )$$

$${b}_{1}^{*} = 200 ( f ( \frac{Y}{{Y}_{n}} ) - f ( \frac{Z}{{Z}_{n}} ) )$$

$$where$$

$$f ( t ) = \{ \begin{matrix}\sqrt[3]{t} , & t > {δ}^{3} \\ \frac{t}{3 {δ}^{2}} + \frac{4}{29} , & otherwise\end{matrix}$$

$$δ = \frac{6}{29} ,$$

$${X}_{n} = 95.0 \; 47 ,$$

$${Y}_{n} = 100 and$$

$${Z}_{n} = 108.8 \; 83 ;$$

Each color point on the color array may have distinct CIE color values, L*2, a*2 and b*2. The L*2, a*2 and b*2 of each color point may be determined by measuring the spectral reflectance or transmittance of the color point and calculating the L*2, a*2 and b*2 values from the measured spectral reflectance or transmittance as disclosed herein.

The comparing step may comprise selecting a color point that substantially corresponds to the desired color of the article. The comparing step may comprise determining the color difference value (ΔE) between the CIE color values of the color point on the color array (L*2, a*2 and b*2) and that of the reference object (L*1, a*1 and b*1) in accordance with the following equations:

ΔE=\sqrt{(L*₂−L*₁)²+(a*₂−a*₁)²+(b*₂−b*₁)²}.

The comparing step may comprise selecting the color point on the color array which results in a ΔE of less than 6, less than 4, or less than 2. In a preferred embodiment, the comparing step may comprise selecting the color point which results in a ΔE of less than 4. More preferably, the comparing step may comprise selecting the color point which results in a ΔE of less than 2. Even more preferably, the comparing step may comprise selecting the color point which results in a ΔE of about 0.

The disclosed method may comprise identifying the resin mixture corresponding to said selected color point. The identified resin mixture may be mixed prior to or during the making step of the disclosed method.

The making step may comprise using the identified resin mixture in a 3D printing process. The 3D printing process may be selected from the group consisting of: stereolithography (SLA), Digital Light Processing (DLP) and Continuous Liquid Interface Production (CLIP). In an embodiment, the 3D printing process may be DLP.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1

FIG. 1(a) shows a color matching tab being compared with a subject's teeth to assess the target shade and/or color of the tooth.

FIG. 1(b) shows a visual shade guide that is presently used in dentistry.

FIG. 2

FIG. 2 shows a diagram illustrating that the preparation of a resin color array for 3D printing may be carried out using master batch resins A, B, C and D.

FIG. 3

FIG. 3 shows a schematic diagram illustrating how all measurements and denture/crown preparation can be carried out. In particular, after digital scanning of a patient's tooth, the computer immediately analyzes the information on the tooth such as 3D dimensions and the color matching. The results will optimize the stereolithography (STL) file of the tooth and send a command to the printer for printing and determine the optimal materials required for color matching. For instance, the composition of the printing resin will be sent to the printer. In particular, based on the spectrophotometric measurement of the patient's tooth, the lab technologist would be aware of the ratio of each master batch to be used. The lab technologist only needs to do a simple blending of the master batch resins and input the information into the printer for 3D printing. After 3D printing and post treatment, real product comparison of the printed tooth/crown with patient's tooth can be achieved immediately. Any flaw or mismatch can be rectified immediately.

FIG. 4

FIG. 4 shows a diagram illustrating the uniform color space, CIEL*a*b*. Color space is a numerical area that expresses and references the object's color. Here, L* indicates the lightness coordinate of the object, with values from 0 (absolute black) to 100 (absolute white). The values a* and b* indicate the chromaticity coordinates, showing the three-dimensional position of the object in the color space and its direction.

FIG. 5

FIG. 5 shows a 36 color array of resins for dental 3D printing. This color array may be prepared by blending a different ratio of each of the master batches A, B and C (obtained from Example 1).

FIG. 6

FIG. 6(a) shows the reflective spectra of the 36 color array resins as shown in FIG. 5.

FIG. 6(b) is a graph showing the corresponding color coordination of the 36 color array resins as shown in FIG. 5. Each color resin is defined by its calculated y-value and its x-value.

FIG. 7

FIG. 7(a) shows a spectral reflectance of each of the x⁻, y⁻ and z⁻ color coordinate value for a sample color.

FIG. 7(b) shows a spectral power distribution of a reference illuminant, D65.

FIG. 8

FIG. 8 demonstrates two (2) examples of dental printing by using resin of different colors.

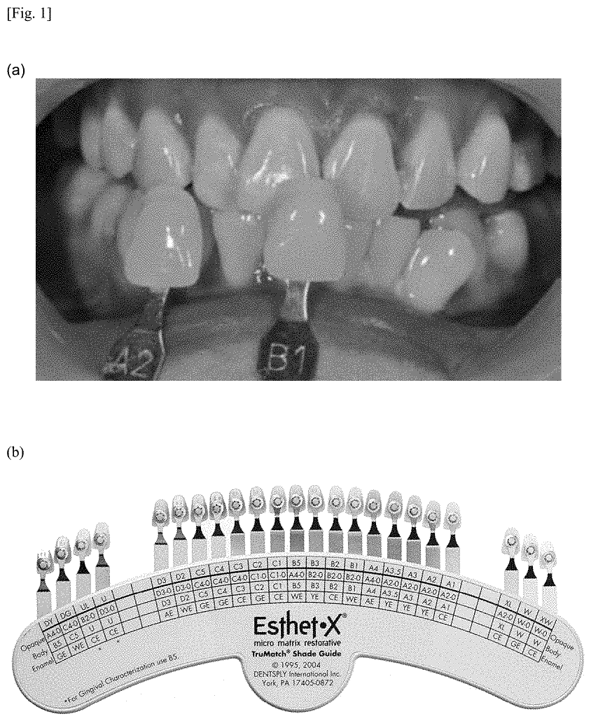

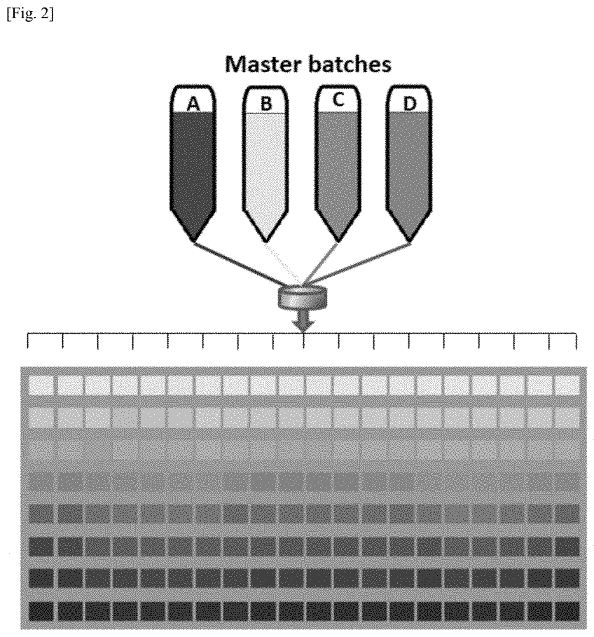

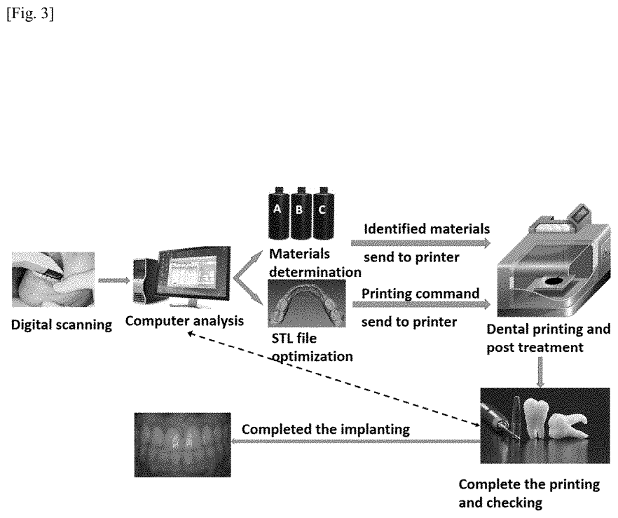

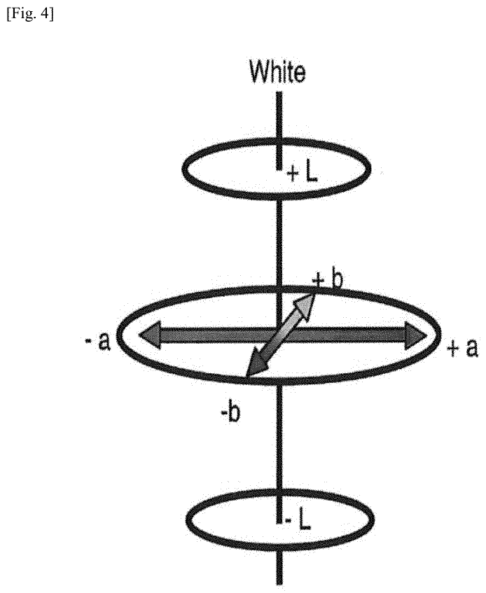

### EXAMPLES

Non-limiting examples of the invention and a comparative example will be further described in greater detail by reference to specific Examples, which should not be construed as in any way limiting the scope of the invention.

### Example 1—Masterbatch Resin Preparation

The formulations of Masterbatch resins A, B, C and D are shown in Tables 1-4. To prepare Masterbatch resin A, all the components listed in Table 1 were weighed into a flask and were stirred in the absence of light for 8-24 hours until all solid contents were dissolved and homogeneous. Masterbatch resins B, C and D were prepared similarly based on the compositions as shown in Tables 2-4 respectively.

TABLE 1
The integration of master batch resin A.

| Ingredient | Percentages (wt %) |
|---|---|
| bisphenol A dimethacrylate | 50 |
| poly(ethylene glycol) diacrylate | 30 |
| tetrahydrofurfuryl methacrylate | 4 |
| Silicon dioxide (200 nm particles size) | 15 |
| Phenylbis(2,4,6-trimethylbenzoyl)phosphine oxide | 0.8 |
| 2,5-Bis(5-tert-butyl-benzoxazol-2-yl)thiophene | 0.2 |

TABLE 2
The integration of master batch resin B.

| Ingredient | Percentages (wt %) |
|---|---|
| bisphenol A dimethacrylate | 50 |
| poly(ethylene glycol) diacrylate | 30 |
| tetrahydrofurfuryl methacrylate | 4 |
| Kaolin (powder, 300 mesh) | 15 |
| Phenylbis(2,4,6-trimethylbenzoyl)phosphine oxide | 0.8 |
| 2,5-Bis(5-tert-butyl-benzoxazol-2-yl)thiophene | 0.2 |

TABLE 3
The integration of master batch resin C.

| Ingredient | Percentages (wt %) |
|---|---|
| bisphenol A dimethacrylate | 50 |
| poly(ethylene glycol) diacrylate | 30 |
| tetrahydrofurfuryl methacrylate | 4 |
| Titanium dioxide (powder, 325 mesh) | 15 |
| Phenylbis(2,4,6-trimethylbenzoyl)phosphine oxide | 0.8 |
| 2,5-Bis(5-tert-butyl-benzoxazol-2-yl)thiophene | 0.2 |

TABLE 4
The integration of master batch resin D.

| Ingredient | Percentages (wt %) |
|---|---|
| bisphenol A dimethacrylate | 50 |
| poly(ethylene glycol) diacrylate | 40 |
| tetrahydrofurfuryl methacrylate | 4 |
| Iron(III) oxide (powder, <5 μm) | 5 |
| Phenylbis(2,4,6-trimethylbenzoyl)phosphine oxide | 0.8 |
| 2,5-Bis(5-tert-butyl-benzoxazol-2-yl)thiophene | 0.2 |

### Example 2—36-Color Array Preparation

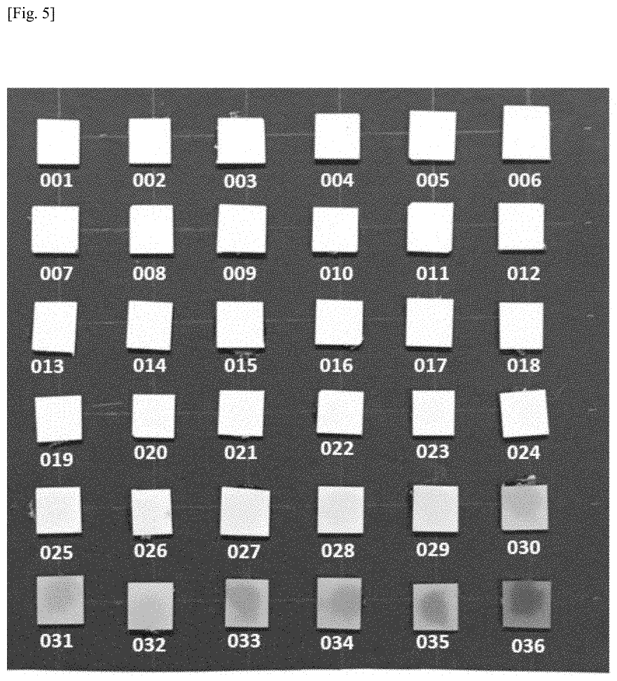

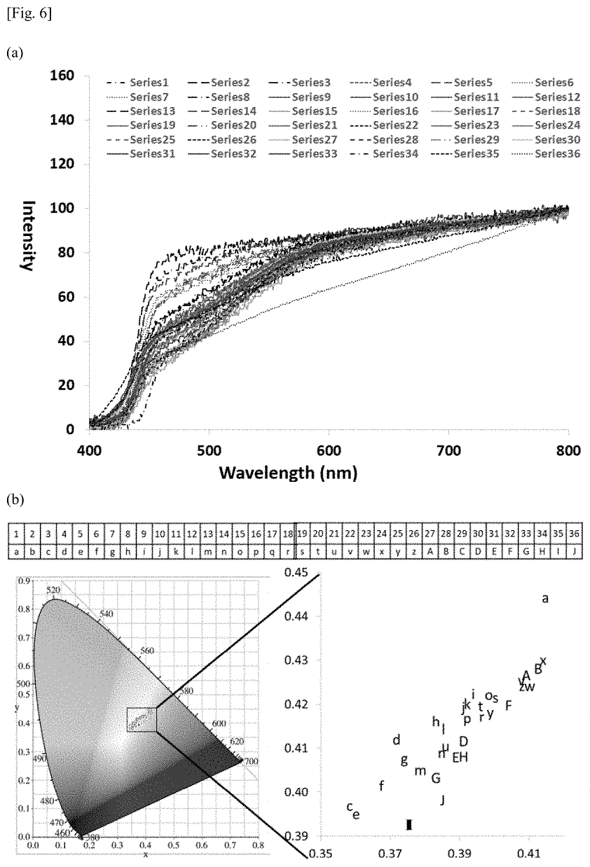

The masterbatch resins A, B and C from Example 1 were blended in accordance with the ratio as shown in Table 5 to build the 36-color array as shown in FIG. 5. For instance, the trial 001 was prepared by mixing 20 g resin A and 20 g of resin C in a bottle and stirring at room temperature for 2 hours until a homogeneous mixture was obtained. Other trials from 002 to 036 were prepared similarly based on the compositions as shown in Tables 5 respectively.

TABLE 5
Composition (mixing ratio) of the color points on the 36-color array

| Number | Resin A | Resin B | Resin C |
|---|---|---|---|
| 001 | 5 | 0 | 5 |
| 002 | 10 | 0 | 0 |
| 003 | 9.7 | 0.3 | 0 |
| 004 | 9.4 | 0.6 | 0 |
| 005 | 9.1 | 0.9 | 0 |
| 006 | 8.8 | 1.2 | 0 |
| 007 | 8.5 | 1.5 | 0 |
| 008 | 8.2 | 1.8 | 0 |
| 009 | 7.9 | 2.1 | 0 |
| 010 | 7.6 | 2.4 | 0 |
| 011 | 7.3 | 2.7 | 0 |
| 012 | 7 | 3 | 0 |
| 013 | 6.7 | 3.3 | 0 |
| 014 | 6.4 | 3.6 | 0 |
| 015 | 6.1 | 3.9 | 0 |
| 016 | 5.8 | 4.2 | 0 |
| 017 | 5.5 | 4.5 | 0 |
| 018 | 5.2 | 4.8 | 0 |
| 019 | 4.9 | 5.1 | 0 |
| 020 | 4.6 | 5.4 | 0 |
| 021 | 4.3 | 5.7 | 0 |
| 022 | 4 | 6 | 0 |
| 023 | 3.7 | 6.3 | 0 |
| 024 | 3.4 | 6.6 | 0 |
| 025 | 3.1 | 6.9 | 0 |
| 026 | 2.8 | 7.2 | 0 |
| 027 | 2.5 | 7.5 | 0 |
| 028 | 2.2 | 7.8 | 0 |
| 029 | 1.9 | 8.1 | 0 |
| 030 | 1.6 | 8.4 | 0 |
| 031 | 1.3 | 8.7 | 0 |
| 032 | 1 | 9 | 0 |
| 033 | 0.7 | 9.3 | 0 |
| 034 | 0.4 | 9.6 | 0 |
| 035 | 0.1 | 9.9 | 0 |
| 036 | 0 | 9 | 1 |

### Example 3—Color Calculation

Step 1: Measuring spectral reflectance S(λ) or transmittance of the target sample with a UV-Vis spectrometer and calculating the X, Y, and Z color coordinates values.

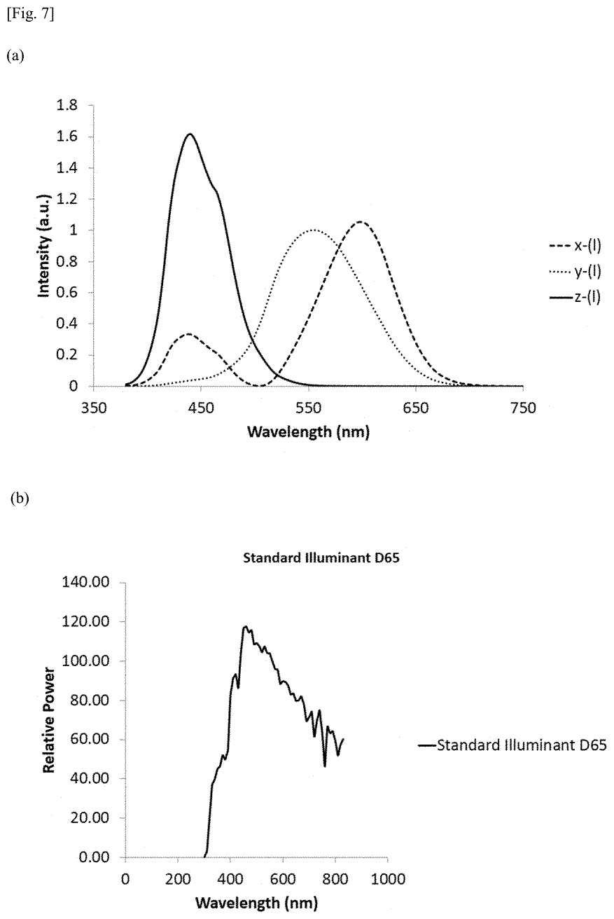

The XYZ color coordinates are calculated based on the following equations:

$$X = \frac{1}{N} {\int }_{λ = 390}^{λ = 830} {x}^{-} ( λ ) S ( λ ) I ( λ ) d λ$$

$$Y = \frac{1}{N} {\int }_{λ = 390}^{λ = 830} {y}^{-} ( λ ) S ( λ ) I ( λ ) d λ$$

$$Z = \frac{1}{N} {\int }_{λ = 390}^{λ = 830} {z}^{-} ( λ ) S ( λ ) I ( λ ) d λ$$

$$N = {\int }_{λ = 390}^{λ = 830} {y}^{-} ( λ ) I ( λ ) d λ$$

where x⁻, y⁻ and z⁻ are the CIE standard observer functions with functions as shown in FIG. 7(a);

where I(λ) is the spectral power distribution of a CIE standard reference illuminant (D65 in this case) with function as shown in FIG. 7(b). The integrals are computed over the visible spectrum (390 nm to 830 nm).

Step 2: Converting the calculated X, Y and Z values may be converted to L*1, a*1 and b*1 values in accordance with the following equations:

$${L}_{1}^{z *} = 116 f ( \frac{Y}{{Y}_{n}} ) - 16$$

$${a}_{1}^{*} = 500 ( f ( \frac{X}{{X}_{n}} ) - f ( \frac{Y}{{Y}_{n}} ) )$$

$${b}_{1}^{*} = 200 ( f ( \frac{Y}{{Y}_{n}} ) - f ( \frac{Z}{{Z}_{n}} ) )$$

$$where$$

$$f ( t ) = \{ \begin{matrix}\sqrt[3]{t} , & t > {δ}^{3} \\ \frac{t}{3 {δ}^{2}} + \frac{4}{29} , & otherwise\end{matrix}$$

$$δ = \frac{6}{29}$$

Here, Xn, Yₙ and Zₙ are the CIE XYZ tristimulus values of the reference white point (the subscript n suggests “normalized”). Under Illuminant D65 with normalization Y=100, the values are: Xₙ=95.047, Yₙ=100 and Zₙ=108.883.

### Example 4—Calculating the Color Difference Value (ΔE)

The color difference value (ΔE) was determined by the CIE color values of the color point on the color array (L*2, a*2 and b*2) with that of the target object (L*1, a*1 and b*1) in accordance with the following equations:

ΔE=\sqrt{(L*₂−L*₁)²+(a*₂−a*₁)²+(b*₂−b*₁)²}.

The color point to be selected for 3D printing corresponds to the one which provided the lowest E. An average difference of up to 3.7 ΔE was considered acceptable in the dental industry according to the Extended Visual Rating Scale for Appearance Match as shown in Table 6. The resin mixture corresponding to the selected color point will be used for 3D printing.

TABLE 6
Extended Visual Rating Scale for Appearance Match (EVRSAM)

| ΔE | Clinical significance |
|---|---|
| 0 | Excellent esthetics with accurate color choice, not being clinically |
| | percieved, or only with great difficulty. |
| 2 | Very slight difference in color, with very good aesthetics. |
| 4 | Obvious difference, but with an average acceptable to most patients. |
| 6 | Poor aesthetics, but within the limits of acceptability. |
| 8 | Aesthetics are very poor and unacceptable to most patients. |
| 10 | Aesthetics are totally unacceptable. |

### Example 5—Dental Printing by Using Different Color Resins

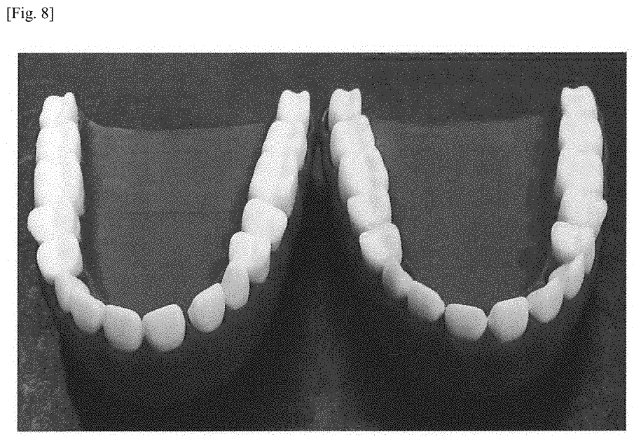

Dentures were printed on a DLP printer (LittleRP with build volume 60 mm (λ) 40 mm (Y) 100 mm (Z) using the resin mixture for preparing the selected color point, which uses DLP projector with a resolution of 1024×768 (Brand & Model: Acer P128) as light source and Creation Workshop as controlling software). Printing was carried out with slice thickness of 50 μm. Exposure time per layer was 30 seconds. After printing, the printed part was washed thoroughly with isopropanol, air dried and placed inside a UV oven for further curing. The printed dentures with different colors are shown in FIG. 8.

### INDUSTRIAL APPLICABILITY

The method may be useful for making a polymeric replicate of a target object with excellent color match with the object. For instance, the method of the present disclosure may be used by dentists to prepare dental prosthetic which matches the color of original patients' teeth. Advantageously, the method of the present disclosure may result in dental prosthetic which very accurately matches the color of the patient's teeth and offers excellent aesthetics.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of making an article having a desired color, the method comprising the steps of:
(a) providing a color array, said array comprising at least 36 color points, each color point having a color value, determined in accordance with the CIE (International Commission of l'Eclairage) system, each color point being independently composed of a resin mixture comprising at least one masterbatch resin;
(b) comparing the desired color with the color points on the color array and selecting a color point that substantially corresponds to the desired color of the article;
(c) identifying the resin mixture corresponding to said selected color point; and
(d) making the article using said identified resin mixture,
wherein the desired color has a CIE color value, as determined by spectral reflectance or transmittance, and
wherein said comparing step comprises selecting a color point from said color array, wherein a color difference value (ΔE) between said color point and the desired color is less than 6.

2. The method of claim 1, wherein the color array comprises at least 144 color points, each color point having a color value, determined in accordance with the CIE system.

3. The method of claim 1, wherein each resin mixture comprises at least two masterbatch resins.

4. The method of claim 3, wherein each resin mixture comprises three to five masterbatch resins.

5. The method of claim 3, wherein a ratio of masterbatch resins in the resin mixture is adjusted to achieve at least 36 color points.

6. The method of claim 1, wherein the desired color is determined based on a color of a reference object, wherein the reference object comprises a human tooth.

7. The method of claim 1, wherein the comparing step further comprises determining the CIE color values of the color points on the color array by measuring the spectral reflectance or transmittance of the color point.

8. The method of claim 7, comprising using a UV-VIS spectrophotometer in the measuring step.

9. The method of claim 1, wherein the comparing step comprises selecting a color point wherein the color difference value (ΔE) between said color point and the desired color is less than 4, or less than 2.

10. The method of claim 1, wherein the making step comprises using said identified resin mixture in a 3D printing process.

11. The method of claim 10, wherein the 3D printing process is selected from the group consisting of: stereolithography (SLA), Digital Light Processing (DLP), and Continuous Liquid Interface Production (CLIP).

12. The method of claim 1, wherein said article is a dental article.

13.-16. (canceled)
